(19) United States
(12) Patent Application Publication
(10) Pub. No.: US 2009/0223179 A1
(43) Pub. Date: Sep. 10, 2009

(54) Bagging Machines and Bags Made Thereby

(75) Inventor: Peter Johnstone, Victoria (AU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: GOODSTONE INTERNATIONAL PTY LTD, Reservoir (AU)

(21) Appl. No.: 11/573,520

(22) PCT Filed: Aug. 3, 2005
(86) PCT No.: PCT/AU2005/001160

§ 371 Date: Jul. 18, 2007

(30) Foreign Application Priority Data
Aug. 12, 2004 (AU) 2004904570

(51) Int. Cl. B65B 43/06; B32B 1/08; B29D 23/00; B65H 81/00; B32B 38/14; B65H 81/04; B31B 41/00

(52) U.S. Cl. 53/562; 428/36.91; 428/35.2; 156/384; 156/425; 156/510; 156/191; 156/277; 156/193; 493/210; 493/267

(57) ABSTRACT

The specification discloses bag making apparatus for making a tube from plastics material web material and for making bags therefrom, the apparatus including a support frame defining a desired internal area of the tube formed thereon, first plastics material film web dispensing means for dispensing first film webs in a longitudinal direction relative to the support frame such that the film webs overlap and adhere to one another, a second plastics material film web dispensing means for laying at least one further film web in overlapping spirals over the longitudinally extending first film web, and a third plastics material film web dispensing means for dispensing third film webs in a longitudinal direction relative to the support frame over the overlapping spiral web material, the apparatus further including movement conveyor means extending longitudinally of the support frame to enable the tube formed thereon to be moved to a discharge region and transverse tube sealing means and associated transverse tube separation means.

### BACKGROUND OF THE INVENTION

1) Field of the Invention

The present invention relates to improved bags made from flexible plastics material webs, particularly adapted for retaining, storing and transporting flowable materials including particulate solids and semi-solid materials, and liquids. The present invention also relates to improved apparatus for, and a method of making the aforesaid bags.

2) Description of Related Art

It is known, for example, to make bags from tubing formed by wrapping flexible plastics material web in a plurality of overlapping helical spirals and closing opposed ends of lengths of such tubing to form a bag. Such bags are inexpensive to produce and can provide quite strong bags to enable heavy loads to be packed, stored or transported therein. One such arrangement is disclosed in U.S. Pat. No. 5,566,530. These types of bags work quite well and are generally inexpensive to manufacture, however, they do have in some forms, certain disadvantages. One such disadvantage is that the helical or spiral wrapping of the film web layers does provide a “washboard effect” in that transverse join regions are formed both internally and externally on the side walls of the bag. Pressure from the filling apparatus or the filling material itself may cause these join regions to open up to some extent, particularly if the edge regions face the filling direction, which may over time cause leakages or bag/wall failure. Similar effects may also occur on the outer surface of the bag over time by weathering or other external influences. Another disadvantage of these systems is the speed of bag formation, filling and closing can be limited if high speed operation in a continuous or semi-continuous basis is desired. A still further disadvantage of known arrangements of this type, particularly when the formed bag is filled under pressure in a vertical direction is that the overall height of the machinery needed for relatively continuous operation is too great for many conventional building sites.

### BRIEF SUMMARY OF THE INVENTION

A first objective of the present invention is to provide an improved bag construction for bags made from plastics material webs, that will overcome some or all of the aforementioned difficulties associated with known bags of this type. A further objective is to provide both a method of making and apparatus for making improved bags of the aforementioned type that can be produced quickly and efficiently on a continuous or semi-continuous basis. A still further objective is to incorporate a method of filling and closing such bags in a continuous or semi-continuous operation.

According to a first aspect of this invention, there is provided a flexible tube for making a bag, said tube being formed from overlapping layers of flexible plastics material webs adhered to one another, the bag being formed as a tube with a first region formed by a plurality of said flexible plastics material webs extending in a longitudinal direction with adjacent edge zones overlapping and adhered to one another, and a second region formed by at least one said flexible plastics material web wrapped in spiral layers with at least adjacent transverse edge zones overlapping and adhered to one another, said first and said second regions being adhered to one another with said first region forming either an inside or an outside surface of the tube.

Preferred features of the aforementioned aspect may be as defined in claims 2 to 8 annexed hereto, the subject matter of these claims being hereby incorporated in the disclosure of this specification by this reference thereto.

In accordance with a second aspect of this invention, a bag making machine is provided including a support frame means for making a tube from plastics material web, the support frame means extending in a longitudinal direction defining an internal space having a predetermined area, first means for laying a plurality of first flexible webs in the longitudinal direction over said support frame or over plastics material web positioned on said support frame whereby said first flexible webs overlap and adhere to one another to form a first region of the tube, second means for laying at least one second said flexible web in a plurality of spiral windings over said support frame or over plastics material web positioned on said support frame whereby said spiral windings include overlapping edge zones adhered to one another to form a second region of the tube, movement means for moving said tube formed by adhering said first and said second regions together in said longitudinal direction, sealing means whereby said tube is closed and sealed across at least one transverse dimension, and separation means to separate a length of said tube from the tube being formed on said support frame to form a bag closed and sealed at at least one end.

Preferred features of the above described second aspect may be as defined in claims 10 to 27 annexed hereto, the subject matter of these claims being hereby incorporated in the disclosure of this specification by this reference thereto.

In accordance with a third aspect of this invention, a method of making a bag formed from overlapping layers of flexible plastics material webs adhered to one another is provided, the method including the steps of laying a plurality of first said flexible webs in the longitudinal direction over a support frame with longitudinal edges of said first flexible webs overlapping to form a tube, laying at least one further said flex web in a plurality of spiral windings outwardly of said first flexible web whereby said spiral windings include overlapping edge zones while said first flexible webs are moved in a longitudinal direction, and transversely separating said tube into lengths with at least one end of said tube lengths being transversely sealed to form a bag.

Preferred features of the above described third aspect may be as defined in claims 29 to 30 and 32 to 36 as annexed hereto, the subject matter of these claims being hereby made part of the disclosure of this specification by this reference thereto.

In accordance with a fourth aspect, the present invention also provides a method of making a bag formed from overlapping layers of flexible plastics material webs adhered to one another, said method including the steps of laying at least one first said flexible web in a plurality of spiral windings on a support frame to form a flexible tube while moving the tube thus formed forwardly in a longitudinal direction, laying a plurality of second said flexible webs in a longitudinal direction over said spiral windings with said second flexible webs having overlapping edge regions, and transversely separating said tube into lengths with at least one end of said tube lengths being transversely sealed to form a bag.

Preferred features of the above described aspect may be as defined in claims 32 to 36 as annexed hereto, the subject matter of these claims being hereby made part of the disclosure of this specification by this reference thereto.

### BRIEF DESCRIPTION OF THE SEVERAL VIEWS OF THE DRAWINGS

Several preferred embodiments of the present invention will hereinafter be described with reference to the accompanying drawings, in which:

FIG. 1 is a schematic side elevation view of apparatus for making a bag according to a preferred embodiment of the present invention;

FIG. 2 is a schematic view similar to FIG. 1 showing an alternative embodiment.

FIG. 3 is a schematic section view along line III-III of FIG. 1.

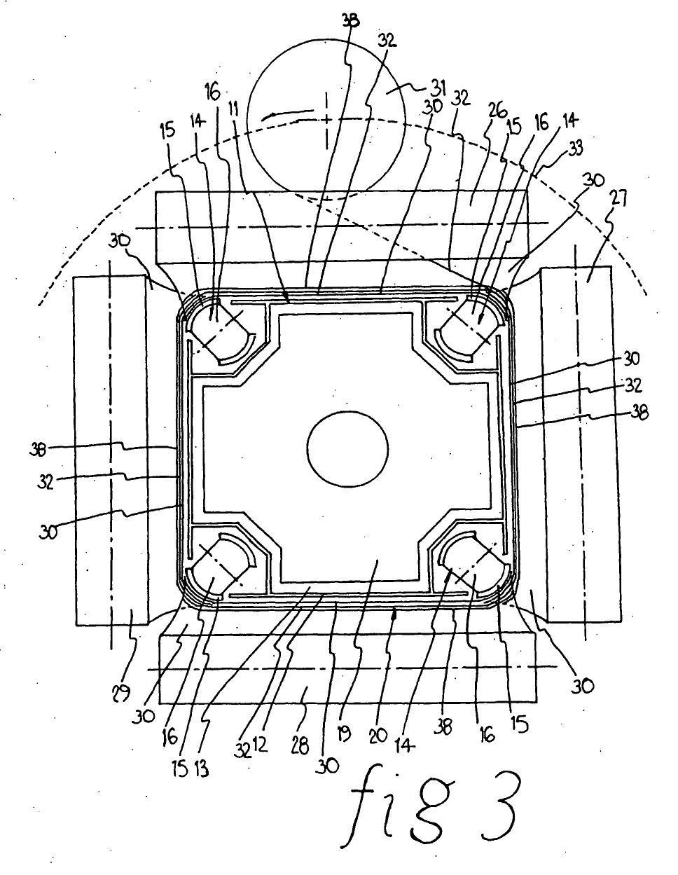

### DETAILED DESCRIPTION OF THE INVENTION

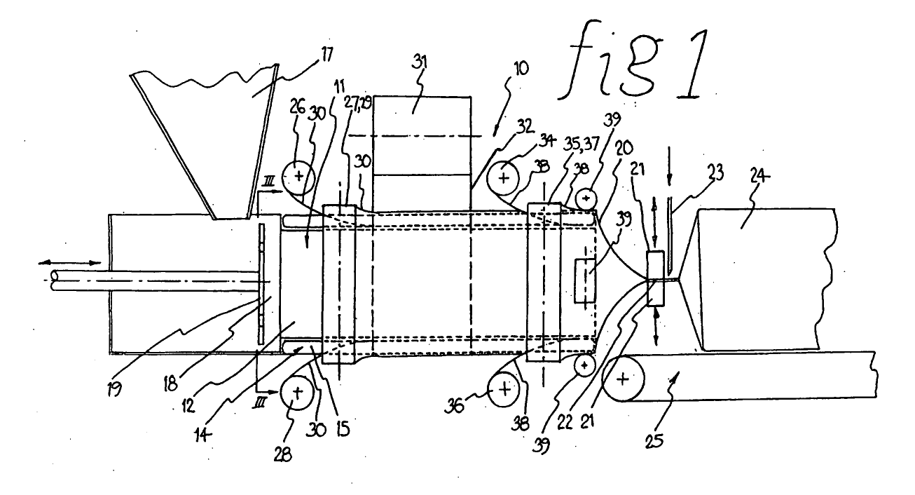

Referring to the drawings, FIG. 1 shows schematically one form of machinery for making and filling bags according to the present invention.

The apparatus 10 includes a support frame 11 which in this embodiment is formed by a closed wall duct 12 having an interior zone 13 for the supply of filling material therethrough. The duct 12 in this embodiment is generally square or rectangular with transport devices 14 located in each of the corners. In the illustrated embodiment, longitudinally extending conveyors with an endless belt 15 supported on a plurality pulleys 16, at least one of which is driven at a desired take off speed that is the same for all of the transport devices 14. In an alternative arrangement, the endless belt conveyors may be replaced by a plurality of in line driven support wheels or by any other equivalent means of transporting the tube 20 to be formed thereon in a forward direction, ie to the right in FIG. 1. In another possible arrangement, the support frame 11 might be formed by an open frame structure, again with transport devices 14 located at its corners. With such a structure, if the bags formed by the machine are to be filled, a separate filling duct may extend through the support frame 11 such that it opens into the tube as it passes from the support frame 11. As further shown in FIG. 1, the filling arrangement might include a hopper 17 delivering material to an infeed chamber or zone 18, which is provided with a reciprocable press platen 19 to press the filling material along the interior zone 13 of the closed wall duct 12 and subsequently into the bag. The press platen 19 may also be used to compress the filling material when it is positioned at least partly in the bag being formed by the machine.

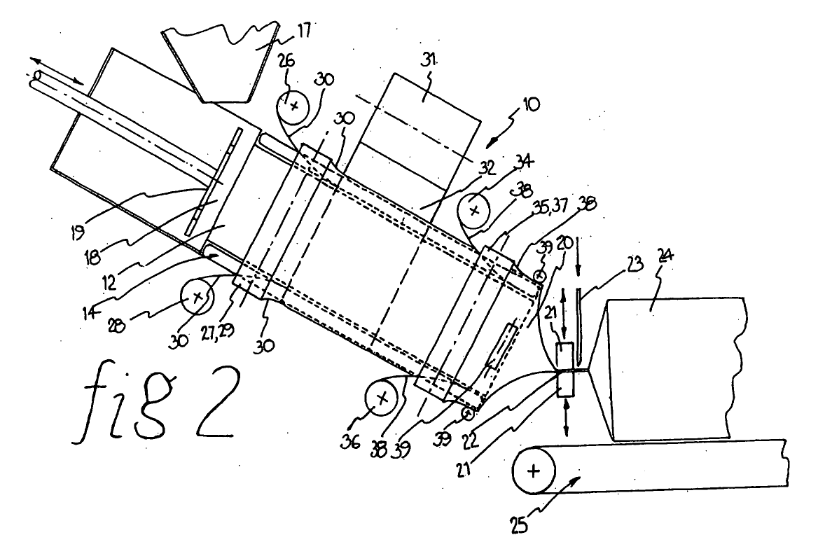

FIG. 1 further schematically illustrates sealing means in the form of sealing jaws 21 for forming a transverse closure and seal 22 in the tube 20 and separation means (cutter knife or the like) 23 for separating the filled and closed bags 24 once produced. A conveyor means 25 of any suitable type may be provided to convey the bags 24 to a storage or transport point as may be desired. The sealing means 21 may form two separate seals or one relatively wide seal with the separation means 23 separating the bags between the two seals or midway between the longitudinal edges of one seal. If considered desirable, guides or guide rollers may be provided to form appropriate gussets in the tube material to assist with the closure and sealing of the tube. The sealing jaws 21 may be heat sealing jaws if the material of the tube 20 is suitable to be sealed in this manner. Any other suitable closure and sealing arrangement could be employed. FIG. 2 illustrates a similar embodiment to that of FIG. 1 except that the longitudinal axis of the machine in FIG. 2 has an inclined downward acute angle to the horizontal whereas in FIG. 1, the longitudinal direction is generally horizontal. As can be seen by providing such arrangements, the overall height of the machine is restricted while still permitting continuous or semi-continuous empty or filled bag production.

Production of the tube 20 and ultimately of the bags formed therefrom may be as follows. In the illustrated embodiment four rolls 26, 27, 28, 29 of flexible plastics material film web 30 are provided located around the support frame 11 such that they each feed a web 30 in the longitudinal direction of the support frame 11 with the respective webs 30 passing along one face each of the closed wall duct 12. The edge zones of each of these webs 30 overlap one another, at least at the corners where the transport devices 14 are located. A further roll 31 of a flexible plastics material film web 32 is provided supported on a rotating carriage device (not shown) to traverse a circumferential path 33 about the support frame 11 with the axis of rotation of the roll 31 extending in the longitudinal direction. As the film webs 30 are moving to the right in FIG. 1 transported by the transport devices 14, the further film web 32 is laid in a plurality of spiral windings over the webs 30 with the edge regions of the web 32 overlapping one another. The film web 32 adheres itself to the underlying layers, particularly at the corner regions and moreover applies pressure in these corner regions to the overlapping zones of the web 30. It will of course be appreciated that more than one roll 31 applying multiple spirally wound webs 32 may be provided if a stronger walled bag is required given the load to be carried thereby.

At the downstream end of the support frame 11, a further array of rolls 34, 35, 36, 37 of flexible plastics material film web are provided each laying a respective second film web 38 over the spirally wound layers with the edge regions overlapping at the corner zones as with the rolls 26 to 29. Press rollers 39 are shown schematically to finally press the adhered layers together. Alternatively, the laminated layers forming the tube 20 might be pressed together by passing the material through circumferentially spaced nip rollers. In a still further possible alternative, the layers may be heat sealed together by passing same through heat sealing jaws that form longitudinal lines of sealing at spaced locations around the tube.

The film web material used for making the laminated tube 20 may conveniently be plastics film having some degree of self adherent characteristics. Plastics film such as linear low density polyethylene is suitable however other plastics film material could also be used. If desired the plastics resin used for making the film might include additives to improve its self adhesive characteristics. If necessary, separate application of adhesives might be utilised between some or all layers. In one preferred arrangement the plastics film may be stretched beyond its yield point to increase its length and decrease its thickness.

In a further preferred arrangement, the machine schematically shown in FIGS. 1 and 2 might be assembled in a portable manner, for example on wheels or other transport devices, such that it might be used in agricultural applications where the filling material might be cut grass collected and stored in the bags produced by the machine for making silage.

While the annexed drawings illustrate a support frame 11 that is used to produce a substantially square cross-sectioned laminated tube 20, other rectangular or polygonal shapes could be used as well as circular or oval cross-sectioned tubes 20. The support frame 11 may readily be constructed such that it is adjustable to vary the size of the tube to be produced. Other variations and modifications within the scope of the annexed claims will be understood by the skilled addressee.

1. A flexible tube for making a bag, said tube being formed from overlapping layers of flexible plastics material webs adhered to one another, the bag being formed as a tube with a first region formed by a plurality of said flexible plastics material webs extending in a longitudinal direction with adjacent edge zones overlapping and adhered to one another, and a second region formed by at least one said flexible plastics material web wrapped in spiral layers with at least adjacent transverse edge zones overlapping and adhered to one another, said first and said second regions being adhered to one another with said first region forming either an inside or an outside surface of the tube.

2. A flexible tube according to claim 1 wherein two said first regions are provided such that they form both the inside and the outside surface of the tube with said second region located therebetween.

3. A flexible tube according to claim 1 wherein the tube has a polygonal shape in cross-section wherein the adjacent edge zones of said longitudinally directed webs overlap only at some or all of the corners of the polygonal shape.

4. A flexible tube according to claim 1 wherein the tube has a polygonal shape in cross-section and a said overlapping edge zone of the longitudinally extending webs being located at each corner of the polygonal shape.

5. A flexible tube according to claim 4 wherein a said overlapping edge zone of the longitudinally extending webs is located at one or more positions between said corners of the polygonal shape.

6. A flexible tube according to claim 4 wherein the polygonal shape is square or rectangular.

7. A bag made from a tube according to claim 1 wherein the tube is transversely closed at one longitudinal end.

8. A bag according to claim 7 wherein the tube is transversely closed at spaced longitudinal ends.

9. A bag making machine including a support frame means for making a tube from plastics material web, the support frame means extending in a longitudinal direction defining an internal space having a predetermined area, first means for laying a plurality of first flexible webs in the longitudinal direction over said support frame or over plastics material web positioned on said support frame whereby said first flexible webs overlap and adhere to one another to form a first region of the tube, second means for laying at least one second said flexible web in a plurality of spiral windings over said support frame or over plastics material web positioned on said support frame whereby said spiral windings include overlapping edge zones adhered to one another to form a second region of the tube, movement means for moving said tube formed by adhering said first and said second regions together in said longitudinal direction, sealing means whereby said tube is closed and sealed across at least one transverse dimension, and separation means to separate a length of said tube from the tube being formed on said support frame to form a bag closed and sealed at at least one end.

10. A bag making machine according to claim 9 wherein said first region is formed by said first means inwardly of the second region formed by said second means.

11. A bag making machine according to claim 10 wherein third means is provided for laying at least one third said flexible web in a longitudinal direction over plastics material webs on said support frame to form a third region of said tube, said third region being positioned outwardly of said second region.

12. A bag making machine according to claim 11 wherein the or one of said third flexible webs has visual printing or other markings on an outwardly facing surface, or is visible outwardly of said tube.

13. A bag making machine according to claim 11 wherein a plurality of said third flexible webs are positioned in said third region with overlapping edge regions adhered to one another.

14. A bag making machine according to claim 9 wherein said support frame defines spaced corners, said movement means being located at said spaced corners.

15. A bag making machine according to claim 14 wherein the movement means includes a plurality of driven rollers configured such that a rolling surface of said driven rollers are aligned with the longitudinal direction.

16. A bag making machine according to claim 14 wherein the movement means includes a driven endless conveyor having at least one run extending in the longitudinal direction.

17. A bag making machine according to claim 14 wherein a said first flexible web fully spans a transverse distance between each adjacent pair of said corners.

18. A bag making machine according to claim 14 wherein a said third flexible web fully spans the transverse distance between each adjacent pair of said corners.

19. A bag making machine according to claim 9 wherein the longitudinal direction is substantially horizontal.

20. A bag making machine according to claim 9 wherein the longitudinal direction is disposed at an acute downwardly inclined angle to the horizontal.

21. A bag making machine according to claim 20 wherein the acute angle is less than 70°.

22. A bag making machine according to claim 19 further including filling means to fill the bag being formed with a flowable material including particulate dry or semi-liquid materials, and liquid materials.

23. A bag making machine according to claim 22 wherein the filling means is formed partly by walls of said support frame defining a passage means leading to the interior of the tube formed outwardly of the support frame.

24. A bag making machine according to claim 22 wherein the filling means is formed partly by a filling material delivery passage disposed within said support frame and leading to the interior of the tube formed outwardly of the support frame.

25. A bag making machine according to claim 23 wherein pressure means is provided to compress the material filled into said tube.

26. A bag making machine according to claim 9 wherein said sealing means simultaneously produces a closing transverse seal for a filled said bag and a transverse seal at said at least one end for a new bag to be filled, the separation means transversely separating the tube between said seals.

27. A bag making machine according to claim 9 wherein said sealing means produces a transverse seal acting both to close a filled bag and to form the transverse seal at said at least one end for a new bag to be filled, the separation means transversely separating the tube through said seal intermediate its longitudinally spaced edges.

28. A method of making a bag formed from overlapping layers of flexible plastics material webs adhered to one another, said method including the steps of laying a plurality of first said flexible webs in the longitudinal direction over a support frame with longitudinal edges of said first flexible webs overlapping to form a tube, laying at least one second said flexible web in a plurality of spiral windings outwardly of said first flexible web whereby said spiral windings include overlapping edge zones while said first flexible webs are moved in a longitudinal direction, and transversely separating said tube into lengths with at least one end of said tube lengths being transversely sealed to form a bag.

29. A method of making a bag according to claim 28 wherein a plurality of third said flexible webs are laid in the longitudinal direction over said spiral windings.

30. A method of making a bag according to claim 29 wherein the third said flexible webs have overlapping edges whereby the outer surface of said tube is formed only by said third flexible webs.

31. A method of making a bag formed from overlapping layers of flexible plastics material webs adhered to one another, said method including the steps of laying at least one first said flexible web in a plurality of spiral windings on a support frame to form a flexible tube while moving the tube thus formed forwardly in a longitudinal direction, laying a plurality of second said flexible webs in a longitudinal direction over said spiral windings with said second flexible webs having overlapping edge regions, and transversely separating said tube into lengths with at least one end of said tube lengths being transversely sealed to form a bag.

32. A method of making a bag according to claim 29 wherein at least one of said second flexible webs includes printed or other visual indicia formed to be visible on an outer surface.

33. A method of making a bag according to claim 28 wherein the plastics material webs are linear low density polyethylene film webs.

34. A method according to claim 33 wherein the film webs include self adherent properties.

35. A method according to claim 34 wherein the linear low density polyethylene film webs include additional materials to improve their self adherent properties.

36. A method according to claim 28 wherein the flexible plastics material webs are plastics material film stretched beyond its yield point to increase its length and reduce its thickness.

37. A method of making a bag according to claim 31 wherein at least one of said second flexible webs includes printed or other visual indicia formed to be visible on an outer surface.

38. A method of making a bag according to claim 31 wherein the plastics material webs are linear low density polyethylene film webs.

39. A method according to claim 31 wherein the flexible plastics material webs are plastics material film stretched beyond its yield point to increase its length and reduce its thickness.
